(19) United States
(12) Patent Application Publication
(10) Pub. No.: US 2004/0038176 A1
(43) Pub. Date: Feb. 26, 2004

(54) Dental instrument

(76) Inventor: Dean Leighton Taylor Hallows, Wokingham (GB)

Correspondence Address: Dale R. Lovercheck, Esquire, DENTSPLY INTERNATIONAL INC., 570 West College Avenue, York, PA, 17405, US

(21) Appl. No.: 10/632,263

(22) Filed: Aug. 1, 2003

Related U.S. Application Data
(60) Provisional application No. 60/401,504, filed on Aug. 7, 2002.

(51) Int. Cl. A61C 3/00

(52) U.S. Cl. 433/141

(57) ABSTRACT

The invention provides a dental instrument having a handle, a connected to a metal tool tip and supporting a nonmetal cover. The nonmetal cover has a central region, between first and second enlarged end regions. The enlarged end regions are on opposite sides of and integrally connected to the central region. The central region has a thinnest point. The greatest thickness of each enlarged end wall is at least 30 percent greater than the least thickness of the central wall.

This application claims the benefit of U.S. Provisional patent application No. 60/401,504 filed Aug. 7, 2002.

The invention relates to a dental instrument having a metal handle with a nonmetal cover. The invention provides a dental instrument having a metal handle with a nonmetal cover that is advantageous in holding the dental instrument.

### BRIEF DESCRIPTION OF THE DRAWING

FIG. 1 is a perspective view of a dental instrument having a metal tool and a nonmetal cover in accordance with the invention.

FIG. 2 is an enlarged cross-sectional side view of the nonmetal cover shown in FIG. 1.

FIG. 2A is a reduced partial cross-sectional side view of the dental instrument shown in FIG. 1.

FIGS. 2B and 2C are enlarged partial cross-sectional side views of the dental instrument shown in FIG. 1.

FIGS. 2D and 2E are end views of the nonmetal cover shown in FIG. 2.

FIG. 3 is a perspective view of the dental instrument of FIG. 1 to which a second metal tool has been added.

FIG. 4 is an enlarged cross-sectional side view of a nonmetal cover for use with a metal tool in accordance with the invention.

FIG. 5 is a perspective view of a streaked nonmetal cover for use in accordance with the invention.

FIG. 6 is a perspective view of a dental instrument having a metal tool and a nonmetal cover in accordance with the invention.

FIG. 7 is a cross-sectional side view of the nonmetal cover and tie bar shown in FIG. 6.

FIG. 7A is a cross-sectional side view of the dental instrument shown in FIG. 6.

FIGS. 7B and 7C are partial cross-sectional side views of the dental instrument shown in FIG. 6.

FIGS. 7D and 7E are end views of the nonmetal cover shown in FIG. 7.

FIG. 8 is a cross-sectional side view of a nonmetal cover for use with a cylindrical metal handle in accordance with the invention.

FIG. 9 is a perspective view of a streaked nonmetal cover for use in accordance with the invention.

### DETAILED DESCRIPTION OF THE INVENTION

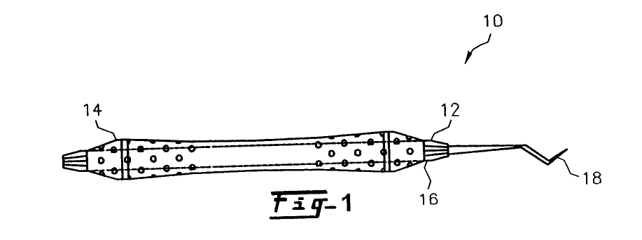

The invention is now described with more particular reference to FIGS. 1 through 9. With more particular reference to FIG. 1 is seen a dental instrument 10 including metal tool 12 and a molded elastomeric cover 14 made of a silicone polymer. The metal tool 12 has a generally cylindrical metal handle 16 and a first tip 18. Handle 16 is connected to the first tip 18. The nonmetal cover 14 is supported by the handle 16.

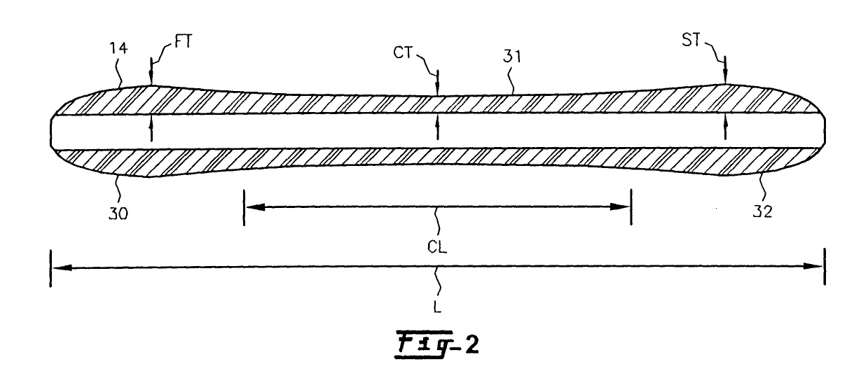

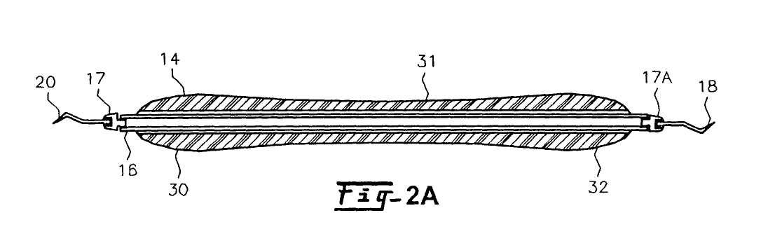

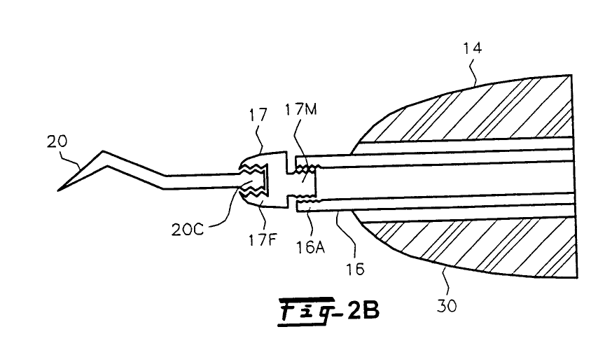

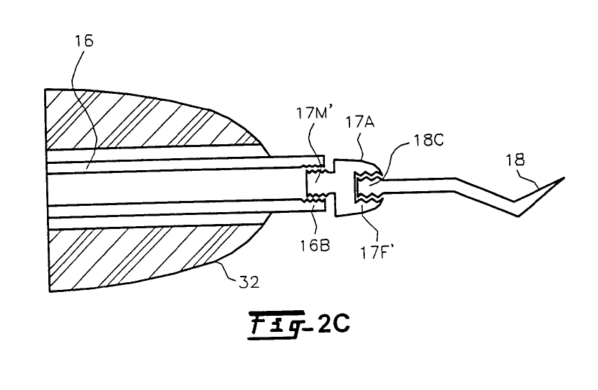

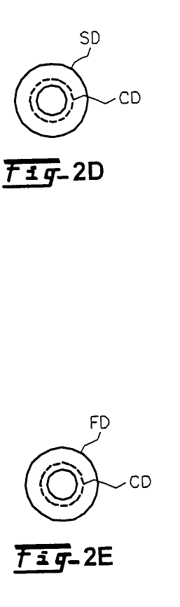

With more particular reference to FIG. 2 it is seen that nonmetal cover 14 has a central region 31, a first enlarged end region 30 and a second enlarged end region 32. Central region 31 is integrally connected to the first and second enlarged end regions 30 and 32. The first and second enlarged end regions 30 and 32 are on opposite sides of the central region 31.

With more particular reference to FIGS. 2A, 2B and 2C it is seen that nonmetal cover 14 cylindrical handle 16 has female threaded ends 16A and 16B which are connected to male threaded connectors 17M and 17M′ of connectors 17 and 17′. Female threaded connectors 17F and 17F′ are connected to male threaded connectors 18C and 20C of tips 18 and 20. Connectors 17 and 17′ are optional, as the male threaded connectors 18C and 20C of tips 18 and 20 may be sized to be connected directly into female threaded ends 16A and 16B of handle 16.

The nonmetal cover has a cover length L. The central region has a central region length CL. The central region length CL is at least 20 percent of the cover length L. Central region length CL is not more than 98 percent of the cover length L. Nonmetal cover 14 has an inner wall forming a generally cylindrical central channel. The central region has a central wall, which has a varying thickness including a central wall least thickness CT. Enlarged end regions 30 and 32 each have an enlarged end wall. Each of the end regions varies in thickness to a greatest thickness FT and ST. End wall greatest thickness FT and ST are each at least 30 percent greater than the central wall least thickness LT. In order of increasing preference first and second enlarged end wall greatest thickness FT and ST are each at least 40, 50, 70, and 100 percent greater than central wall least thickness LT.

With more particular reference to FIGS. 2, 2D and 2E it is seen that central region 31 has a thinnest point CP and central smallest outer diameter CD at the thinnest point CP. First enlarged end region 30 has a thickest point FP and a first end largest outer diameter FD at the thickest point FP. Second enlarged end region 32 has a thickest point SP and a second end largest outer diameter SD at the thickest point SP. First end largest outer diameter FD, and the second end largest outer diameter SD each is at least 30 percent greater than the central smallest diameter CD.

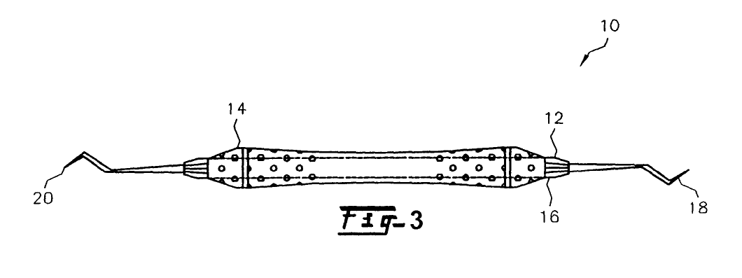

With more particular reference to FIG. 3 is seen a dental instrument 10 including metal tool 12 and a nonmetal cover 14. The metal tool 12 has a handle 16 and a first tip 18. The handle 16 is connected to the first tip 18 and second tip 20. The nonmetal cover 14 is supported by the handle 16.

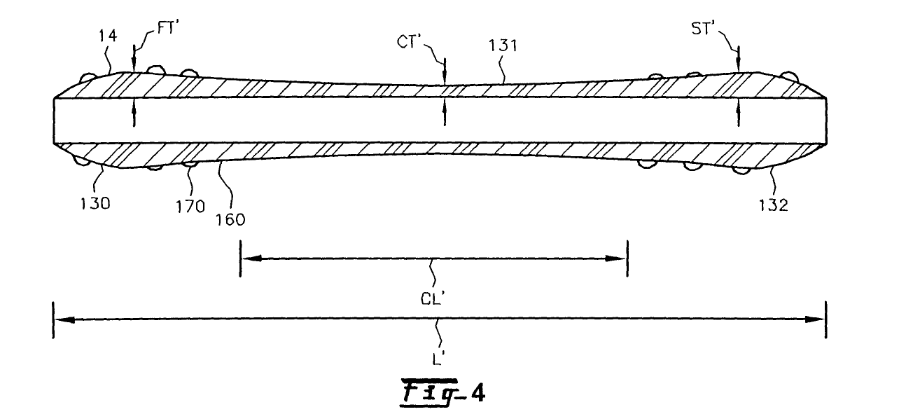

With more particular reference to FIG. 4 is seen nonmetal cover 114 for use with a metal tool in accordance with the invention. Nonmetal cover 114 has an outer surface 160 having a plurality of raised portions 170. Nonmetal cover 114 has a central region 131, a first enlarged end region 30 and a second enlarged end region 132. Central region 131 is integrally connected to the first and second enlarged end regions 130 and 132. The first and second enlarged end regions 130 and 132 are on opposite sides of the central region 131.

The nonmetal cover 114 has a cover length L′. The central region 131 has a central region length CL′. The central region length CL′ is at least 20 percent of the cover length L′. Central region length CL′ is not more than 98 percent of the cover length L′. Nonmetal cover 114 has an inner wall forming a generally cylindrical central channel. The central region has a central wall, which has a varying thickness including a central wall least thickness CT′. Enlarged end regions 130 and 132 each has a varying thickness enlarged end wall, with end wall greatest thickness FT′ and ST′. Enlarged end wall greatest thickness FT′ and ST′ are each at least 30 percent greater than central wall least thickness CT′. In order of increasing preference first and second enlarged end wall greatest thickness FT′ and ST′ are each at least 40, 50, 70, and 100 percent greater than central wall least thickness LT′.

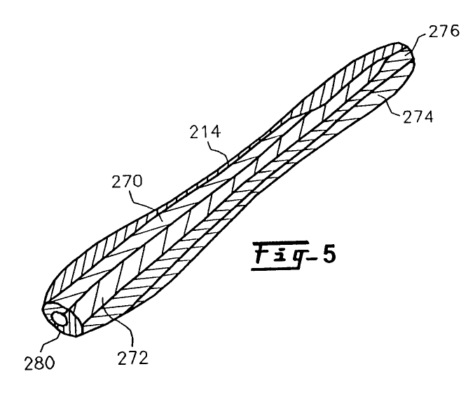

With more particular reference to FIG. 5 is seen streaked nonmetal cover 214 for use with a metal tool in accordance with the invention. Streaked nonmetal cover 214 is made by extruding a plurality of colors: 270 (blue), 272 (orange), 274 (green) and 276 (yellow) of elastomer into a cylindrical outer form having cylindrical inner channel 280 and then molding the cylindrical outer form into the shape shown in FIG. 5. Streaked nonmetal cover 214 may be used in place of nonmetal covers 14 and 114.

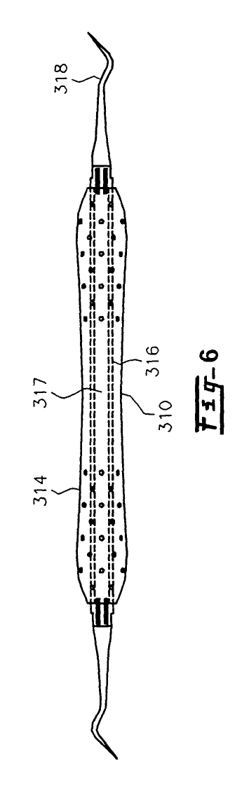

With more particular reference to FIG. 6 is seen a dental instrument 310 includes first metal tool tip 318, a nonmetal cover 314 and a metal handle tube 316. The first metal tool tip 318 is an interchangeable tip fixed to metal handle tube 316 by metal tie bar 317.

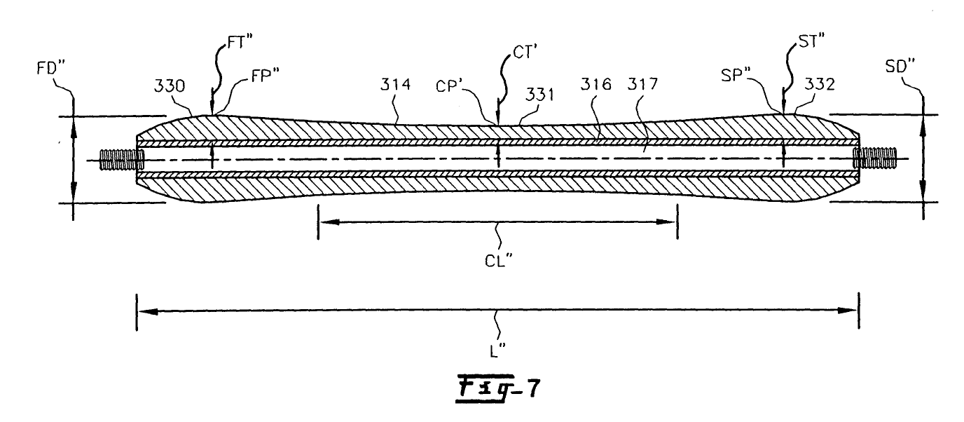

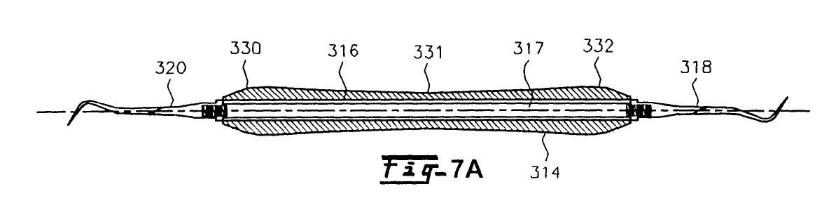

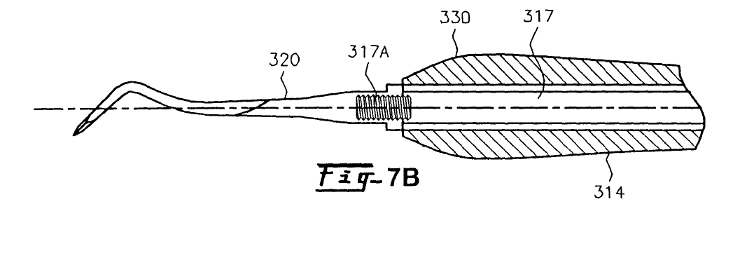

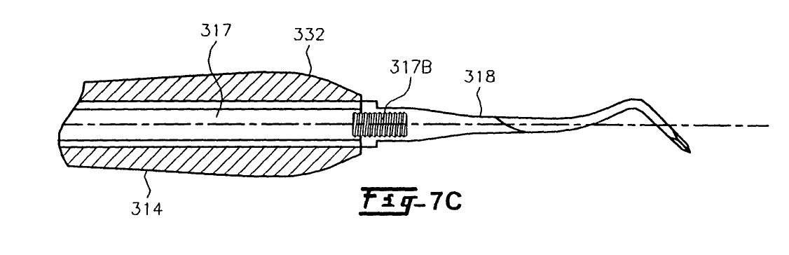

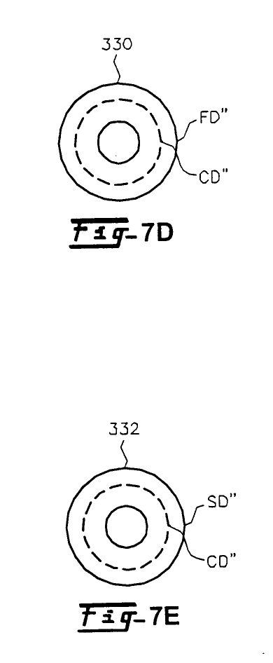

With more particular reference to FIGS. 7A, 7B and 7C it is seen that nonmetal cover 314 is bonded to the metal handle tube 316. The metal tie bar 317 is positioned through the center of the metal handle tube 316 and tool tips 318 and 320 are connected to threaded ends 317A and 317B of metal tie bar 317. The nonmetal cover has a cover length L″. The central region has a central region length CL″. The central region length CL″ is at least 20 percent of the cover length L″. Central region length CL″ is not more than 98 percent of the cover length L″. Nonmetal cover 314 has an inner wall forming a generally cylindrical central channel. The central region has a central wall, which has a varying thickness including a central wall least thickness CT″. Enlarged end regions 330 and 332 each has a varying thickness with end wall greatest thickness FT″ and ST″. Enlarged end wall greatest thickness FT″ and ST″ are each at least 30 percent greater than the central wall least thickness LT″. In order of increasing preference first and second enlarged end wall greatest thickness FT″ and ST″ are each at least 40, 50, 70, and 100 percent greater than central wall least thickness LT″.

With more particular reference to FIGS. 7, 7D and 7E, it is seen that non-metal cover 314 has a central region 331, and enlarged end regions 330 and 332. Central region 331 is integrally connected to the first and second enlarged end regions 330 and 332. The first and second enlarged end regions 330 and 332 are on opposite sides of the central region 331. It is also seen that the central region 331 has a thinnest point CP″ and central smallest outer diameter CT″ at the thinnest point CP″. First enlarged end region 30 has thickest point FP″ and a first end largest outer diameter FD″ at the thickest point FP″. Second enlarged end region 332 has a thickest point SP″ and a second end largest outer diameter SD″ at the thickest point SP″. First end largest outer diameter FD″ and the second end largest outer diameter SD″ each is at least 330 percent greater than the central smallest diameter CD″.

The nonmetal cover has a cover length L″. The central region has a central region length CL″. The central region length CL″ is at least 20 percent of the cover length L″. Central region length CL″ is not more than 98 percent of the cover length L″. Non-metal cover 314 is supported by a metal handle tube 316 forming a generally cylindrical central channel. The metal tie bar 317 is placed through the cylindrical central channel.

The central region has a central wall, which has a varying thickness including a central enlarged end wall least thickness CT″. Enlarged end regions 330 and 332 each has an end wall, of varying thickness including end wall greatest thickness FT″ and ST″. Enlarged end wall greatest thickness FT″ and ST″ each are at least 30 percent greater than the central wall least thickness CT″. In order of increasing preference first and second enlarged end wall greatest thickness FT″ and ST″ are each at least 40, 50, 70, and 100 percent greater than central wall least thickness CT″.

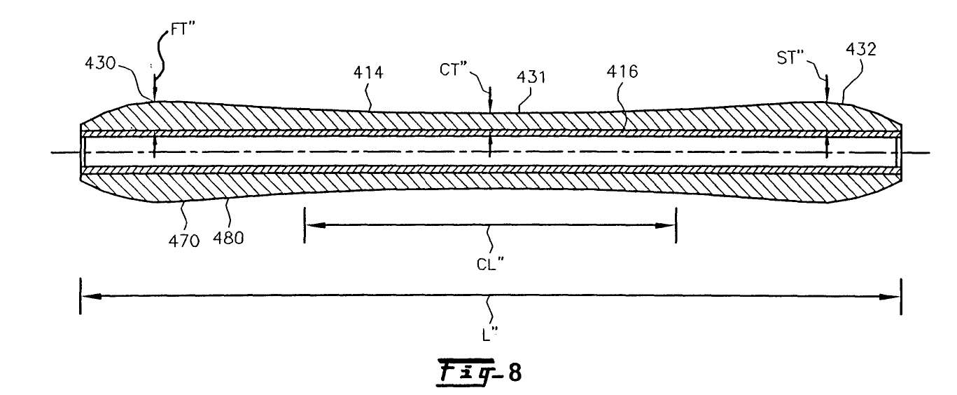

With more particular reference to FIG. 8 is seen nonmetal cover 414 for use with a metal tool in accordance with the invention. Nonmetal cover 414 has an outer surface 460 having a plurality of raised portions 470. Nonmetal cover 414 has a central region 431, a first enlarged end region 430 and a second enlarged end region 432. Central region 431 is integrally connected to the first and second enlarged end regions 430 and 432. The first and second enlarged end regions 430 and 432 are on opposite sides of the central region 431.

The nonmetal cover 414 has a cover length L′″. The central region 431 has a central region length CL′″. The central region length CL′″ is at least 20 percent of the cover length L′″. Central region length CL′″ is not more than 98 percent of the cover length L′″. Nonmetal cover 414 is fixed to a metal handle tube 416 forming a generally cylindrical central channel. The central region has a central wall, which has a varying thickness including a central enlarged end wall least thickness CT′″. First enlarged end region 430 has a first enlarged end wall, which has a varying thickness including a first enlarged end wall greatest thickness FT′″. The second enlarged end region 432 has a second enlarged end wall, which has a varying thickness including a second enlarged end wall greatest thickness ST′″. The first enlarged end wall greatest thickness FT′″ and the second enlarged end wall greatest thickness ST′″ each are at least 30 percent greater than the central wall least thickness CT′″. In order of increasing preference first and second enlarged end wall greatest thickness FT′″ and ST′″ are each at least 40, 50, 70, and 100 percent greater than central wall least thickness CT′″.

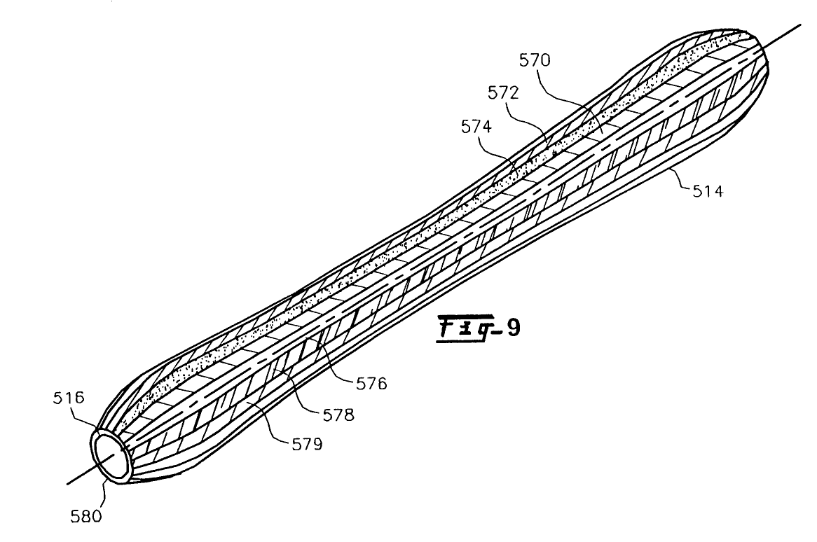

With more particular reference to FIG. 9 is seen streaked nonmetal cover 514 for use with a metal tool in accordance with the invention. Streaked nonmetal cover 514 is made by extruding any combination of colors 570 (blue), 572 (orange), 574 (green), 576 (yellow), 578(Lilac) and 579 (Pink) of elastomer onto a metal handle tube 516 and a cylindrical outer form having cylindrical inner channel 580 and then molding the cylindrical outer form into the shape shown in FIG. 9. Streaked nonmetal cover 514 may be used in place of nonmetal covers 14, 114, 214 and 314.

Preferably nonmetal covers 14, 114, 214, 314 and 414 each comprises elastomeric material, such as silicone polymer, and is adhered by an adhesive to the metal handle 16, 116, 216, 316 and 416. Preferably elastomeric material has a shore hardness of less than 60.

Preferably nonmetal covers 14, 114, 214, 314 and 414 each comprises elastomeric material having a plurality of colors. For example the colors may form generally parallel streaks of solid colors.

Preferably the central regions 31, 131, 231, and 331 each have a central region outer surface, a portion of which is generally shaped like the central portion of one of the elongated sides of an ellipse, when the central region 31, 131, 231 and 331 is viewed in longitudinal cross-section. Preferably the handle is effectively and substantially cylindrical.

Thus, the invention provides dental instrument having a generally cylindrical handle, a metal tool tip and a molded elastomeric cover having an outer surface. The metal tool tip has a sharp edge. The handle is connected to the first tip. The nonmetal cover is supported by the handle. The cover has a central region, and a first and a second enlarged end region on opposite sides of the central region and integrally connected to the central region. The central region has a central wall having a smallest outer diameter at point of least wall thickness. The first and second enlarged end regions each have a largest outer diameter at a greatest wall thickness at a thickest point on the outer surface of the cover. Each of the greatest wall thickness is at least 30 percent greater than the least wall thickness.

Preferably at least one greatest wall thickness is at least 40 (more preferably at least 50) percent greater than the least wall thickness. Preferably the cover has a length with a midpoint and two end points, and the least wall thickness is within 20 percent of the cover length from the midpoint of the cover length, and each greatest wall thickness is within 20 percent of the cover length from each end point of the cover length.

More preferably at least one greatest wall thickness is at least 70 percent greater than the least wall thickness. Preferably the cover has a length with a midpoint and two end points, and the least wall thickness is within 10 percent of the cover length from the midpoint of the cover length, and each greatest wall thickness is within 10 percent of the cover length from each end point of the cover length. Preferably the cover outer surface is generally smooth and substantially continuously curved with intermittent protrusions.

It should be understood that while the present invention has been described in considerable detail with respect to certain specific embodiments thereof, it should not be considered limited to such embodiments but may be used in other ways without departure from the spirit of the invention and the scope of the appended claims.

What is claimed is:

1. A dental instrument comprising:
a generally cylindrical handle, a first metal tool tip and an elastomeric cover having an outer surface,
said handle being connected to said first metal tool tip,
said nonmetal cover being supported by said handle,
said cover having a central region, and a first and a second enlarged end region on opposite sides of said central region and integrally connected to said central region,
said central region having a central wall, said central wall having a smallest outer diameter at point of least wall thickness,
said first and said second enlarged end region each having having a largest outer diameter at a greatest wall thickness at a thickest point on said outer surface of said cover,
each said greatest wall thickness being at least 30 percent greater than said least wall thickness.

2. The dental instrument of claim 1 wherein at least one of said greatest wall thickness is at least 40 percent greater than said least wall thickness, and said cover has a length with a midpoint and two end points, said least wall thickness is within 20 percent of said cover length from said midpoint of said cover length, and each said greatest wall thickness is within 20 percent of said cover length from each said end point of said cover length.

3. The dental instrument of claim 1 wherein at least one of said greatest wall thickness is at least 50 percent greater than said least wall thickness, and said cover outer surface is generally smooth and substantially continuously curved with intermittent protrusions.

4. The dental instrument of claim 1 wherein at least one of said greatest wall thickness is at least 70 percent greater than said least wall thickness, and said cover has a length with a midpoint and two end points, said least wall thickness is within 10 percent of said cover length from said midpoint of said cover length, and each said greatest wall thickness is within 10 percent of said cover length from each said end point of said cover length.

5. The dental instrument of claim 1 wherein at least one of said greatest wall thickness is at least 100 percent greater than said least wall thickness.

6. The dental instrument of claim 1 wherein said dental instrument further comprises a second tip.

7. The dental instrument of claim 1 wherein said nonmetal cover has an outer surface having a plurality of raised portions.

8. The dental instrument of claim 1 wherein said nonmetal cover comprises silicone polymer.

9. The dental instrument of claim 1 wherein said nonmetal cover comprises elastomeric material.

10. The dental instrument of claim 1 wherein said nonmetal cover is adhered by an adhesive to said handle.

11. The dental instrument of claim 1 wherein said nonmetal cover comprises elastomeric material having a shore hardness of less than 60.

12. The dental instrument of claim 1 wherein said nonmetal cover comprises elastomeric material having a plurality of colors.

13. The dental instrument of claim 1 wherein said plurality of colors form generally parallel streaks.

14. The dental instrument of claim 1 wherein said central region has a cover outer surface and at least of portion of said central region outer surface is generally shaped like the central portion of one of the elongated sides of an ellipse when the central region is viewed in longitudinal cross-section.

15. The dental instrument of claim 1 wherein said handle is effectively and substantially cylindrical.

16. The dental instrument of claim 1 wherein said central region length has a length of not more than 98 percent of the length of the cover.

17. The dental instrument of claim 1 further comprising a first connector, said first connector being connected to said handle and said first tip.

18. The dental instrument of claim 17 further comprising a second tip and a second connector, said second connector being connected to said handle and said second tip.

19. A dental instrument comprising:
a generally cylindrical metal handle, a first and a second tip and a cover comprising elastomeric material,
said handle being connected to said first and said second tip,
said cover being supported by said handle,
said cover having a central region, and a first and a second enlarged end region on opposite sides of said central region and integrally connected to said central region,
said central region having a central wall, said central wall having a smallest outer diameter at point of least wall thickness,
said first and said second enlarged end region each having an end wall, each said end wall having a largest outer diameter at a point of greatest wall thickness,
each said greatest wall thickness being at least 30 percent greater than said least wall thickness.

20. The dental instrument of claim 19 wherein said cover comprises silicone polymer.

21. A dental instrument, comprising:
a nonmetal cover,
a cylindrical metal handle tube having a central channel,
a metal tie bar, and
a first metal tool tip and a second metal tool tip,
each said tool tip being connected to an opposite end of said metal tie bar, said nonmetal cover being supported by said cylindrical metal handle tube, said metal tie bar extending through said central channel of said cylindrical metal handle tube,
said cover having a central region, and a first and a second enlarged end region on opposite sides of said central region and integrally connected to said central region,
said central region having a central wall, said central wall having a smallest outer diameter at point of least wall thickness,
said first and said second enlarged end region each having an end wall, each said end wall having a largest outer diameter at a point of greatest wall thickness,
each said greatest wall thickness being at least 30 percent greater than said least wall thickness.
